(19) United States
(12) Patent Application Publication
(10) Pub. No.: US 2026/0049896 A1
(43) Pub. Date: Feb. 19, 2026

(54) LINE MONITORING SYSTEM HAVING FREQUENCY MODULATION FOR NOISE REDUCTION

(71) Applicant: SUBCOM, LLC, Eatontown, NJ (US)

(72) Inventors: Jin-Xing Cai, Morganville, NJ (US); Yanjie Chai, Marlboro, NJ (US); Govind Vedala, Somerset, NJ (US); Alexei N. Pilipetskii, Long Branch, NJ (US)

(73) Assignee: SUBCOM, LLC, Eatontown, NJ (US)

(21) Appl. No.: 18/806,119

(22) Filed: Aug. 15, 2024

(51) Int. Cl. G01M 11/00

(52) U.S. Cl. CPC G01M 11/3118; G01M 11/3145

(57) ABSTRACT

A sensing system. The sensing system may include a transmitter to launch an outbound optical signal, a clock to generate a clock signal, and a chirp subcarrier coupled to the clock and configured to generate a chirp. The sensing system may further include a code generator coupled to the clock and configured to generate a code; and an intensity modulator, arranged to modulate the outbound optical signal and coupled to receive an intensity modulator signal that is derived at least in part from the code generator.

### BACKGROUND

### Field

Embodiments of the present disclosure relate to the field of optical communication systems. In particular, the present disclosure relates to techniques for improving line monitoring equipment using frequency modulation.

### Discussion of Related Art

Undersea optical communications systems may employ optical cables in systems that span hundreds of kilometers or up to many thousands of kilometers. Line Monitoring Equipment may be employed to probe the state of components along such an undersea system. In particular, the use of Optical Time-Domain Reflectometry (OTDR) together with High-Loss Loop-Back technology provides an enormously powerful tool in monitoring the health of undersea systems, including monitoring pump power degradation, fiber aging induced loss increases, and cable fault localization. OTDR employs detection of a Rayleigh backscattered signal based upon a probe signal that is sent through an optical fiber. Since the power from a backward Rayleigh reflection is exceedingly small, simplex codes or complementary Golay codes are often used to enhance the weak signal thanks to the autocorrelation feature (a delta function) provided in such codes.

On the other hand, envelope (or square law) detection is often used to down convert the IF frequency (˜1 GHz) to DC (the IF frequency is indispensable to combat signal polarization issues)—this process leads to signal beating among Rayleigh reflection signals that are received from different distances along an optical cable. The signal-signal beating noise increases the noise floor and leads to large signal-to-noise (SNR) variation.

In known LME systems using HLLB, after an outbound signal is sent along a fiber in a forward direction from a transmitter, the reflection from a fiber Bragg gating (FBG) or Rayleigh backscattering passes through an optical loopback path connected by two optical couplers (usually 10%), and coupled back to the reverse direction. The reflected signal then travels back to a receiver that is placed in the same location as the transmitter and is analyzed in the receiver.

As the name indicates, the loss of HLLB is extremely high. For in-service LME channels reflected from FBG, the optical loss of the HLLB is ˜32 dB, and this loss increases up to 54 dB for out of service channels reflected from Rayleigh backscattering process. To increase the sensitivity, many averages are needed to suppress the noise in order to pick up the extremely weak signal. Simplex codes or complementary Golay codes are often used to enhance the weak signal thanks to their nice autocorrelation feature (a delta function). As used in the present disclosure, the term “Golay code” may refer to any code that is suitable to enhance signal SNR with a correlation process.

The optical signal amplitude vs time before a receiver is the sum of Rayleigh reflections from all points along an optical link:

$${\sum }_{{l}_{i} = 0}^{{l}_{i} = {L}_{Link}} A ( {t}_{i} ) {e}^{- 2 α {l}_{i}} ,$$

where time tᵢ and distance lᵢ is related by lᵢ=(2nctᵢ) mod (L_{Span}). The optical signal is typically received with an optical detector that performs a square law detection:

$${[ {\sum }_{{l}_{i} = 0}^{{l}_{i} = {L}_{Link}} A ( {t}_{i} ) {e}^{- 2 α {l}_{i}} + ]}^{2} = {\sum }_{{l}_{i} = 0}^{{l}_{i} = {L}_{Link}} {A ( {t}_{i} )}^{2} {e}^{- 4 α {l}_{i}} + {\sum }_{{l}_{j} = 0}^{{l}_{i} = {L}_{Link}} {\sum }_{{l}_{j} \neq {l}_{i} ; {l}_{j} = 0}^{{l}_{j} = {L}_{Link}} A ( {t}_{i} ) A ( {t}_{j} ) {e}^{- 2 α ( {l}_{i} + {l}_{j} )}$$

To detect signal at location lᵢ, the received signal is correlated with the Golay sequence corresponding to [A(tᵢ)]², and the correlation process enhances the SNR by N times (N is the Golay code length). However, there exists signal-signal beating terms

$${\sum }_{{l}_{j} \neq {l}_{i} ; {l}_{j} = 0}^{{l}_{j} = {L}_{Link}} A ( {t}_{i} ) A ( {t}_{j} ) {e}^{- 2 α ( {l}_{i} + {l}_{j} )} ,$$

after the square law detection, and this beating terms serves as noise to the signal and degrade SNR.

It is with respect to these and other considerations that the present disclosure is provided.

### BRIEF SUMMARY

In one embodiment, a sensing system is provided. The sensing system may include a transmitter to launch an outbound optical signal, a clock to generate a clock signal, and a chirp subcarrier coupled to the clock and configured to generate a chirp. The sensing system may further include a code generator coupled to the clock and configured to generate a code; and an intensity modulator, arranged to modulate the outbound optical signal and coupled to receive an intensity modulator signal that is derived at least in part from the code generator.

In another embodiment, an optical communication system is provided. The optical communications system may include a transmitter to launch a line monitoring signal (LMS) as an outbound optical signal along an outbound path, a loopback to route a Rayleigh reflection signal based upon the LMS to a return path, and a receiver to receive the Rayleigh reflection signal from the return path. The transmitter may include a clock to generate a clock signal, a chirp subcarrier coupled to the clock and configured to generate a chirp, a code generator coupled to the clock and configured to generate a code, and an intensity modulator, arranged to modulate the outbound optical signal and coupled to receive an intensity modulator signal that is derived at least in part from the code generator.

In a further embodiment, a method is provided. The method may include launching an outbound optical signal over a first signal path, and applying a step chirp to the outbound optical signal, wherein a stepped outbound signal is generated, comprising a stepped frequency variation as a function of time. The method may further include receiving a Rayleigh backscattering signal over a second signal path, the Rayleigh backscattering signal being based upon the stepped outbound signal, and processing the Rayleigh backscattering signal to determine a location of an origin of the Rayleigh backscattering signal, based upon a frequency of the Rayleigh backscattering signal.

### BRIEF DESCRIPTION OF THE DRAWINGS

FIG. 1 illustrates a line monitoring equipment system according to embodiments of the disclosure

FIG. 2A and FIG. 2B illustrate the optical amplitude vs time of Rayleigh backscattering signals generated from different distances away from a receiver;

FIG. 3A presents a graph depicting frequency of a given set of signals as a function of time that are generated by an FM-OTDR system under one scenario, according to one embodiments;

FIG. 3B shows another graph depicting frequency of a given set of signals as a function of time for another scenario, analogous to FIG. 3A;

FIG. 3C shows beating frequency between an LO and Rayleigh reflection versus location;

FIG. 4A is a composite illustration, depicting features of a non-coherent detection scenario;

FIG. 4B is a composite illustration, where the graph depicts the power spectral density (PSD) vs frequency (location) in the case of coherent detection;

FIG. 5A is a block diagram depicting various components of FM-OTDR system, according to some embodiments of the disclosure;

FIG. 5B is a block diagram depicting various components of FM-OTDR system, according to other embodiments of the disclosure;

FIG. 5C depicts a modified FM-OTDR system, shown as system 580, according to other embodiments of the disclosure;

FIG. 5D depicts another FM-OTDR system according to further embodiments of the disclosure;

FIG. 6A depicts a block diagram of a receiver for an FM-OTDR system, according to some embodiments of the disclosure;

FIG. 6B depicts a block diagram of a receiver for an FM-OTDR system, according to additional embodiments of the disclosure; and

FIG. 7 presents an exemplary process flow 700.

### DESCRIPTION OF EMBODIMENTS

The present embodiments will now be described more fully hereinafter with reference to the accompanying drawings, in which exemplary embodiments are shown. The scope of the embodiments should not be construed as limited to the embodiments set forth herein. Rather, these embodiments are provided so that this disclosure will be thorough and complete, and will fully convey the scope of the embodiments to those skilled in the art. In the drawings, like numbers refer to like elements throughout.

Before detailing specific embodiments with respect to the figures, general features with respect to the embodiments will be reviewed. As detailed in the description to follow, the present embodiments provide a Frequency Modulated OTDR (FM-OTDR) approach to reduce signal interference noise penalty in a line monitoring system by letting the beating frequency to fall out of the signal baseband.

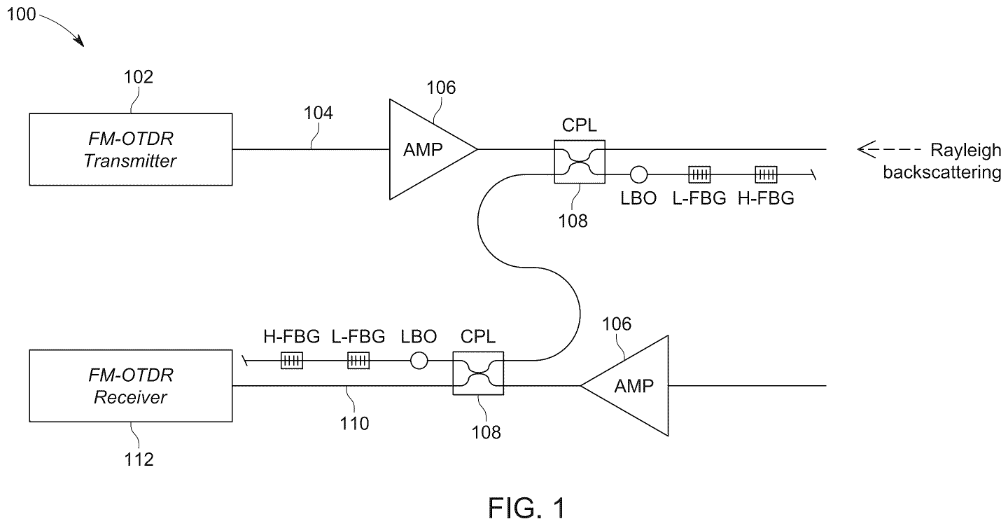

FIG. 1 illustrates a line monitoring equipment (LME) system according to embodiments of the disclosure. As in known HLLB systems, the LME system 100 includes a transmitter 102 to launch a probe signal on a first signal path 104, a first amplifier 106, to amplify the probe signal, a pair of couplers 108 forming a loopback that directs a Rayleigh backscatter signal to a second signal path 110 that operates as a return path, and a receiver 112, to receive and analyze the Rayleigh backscatter signal. In addition, the transmitter includes a frequency modulation system to achieve frequency modulated OTDR, as detailed in embodiments to follow.

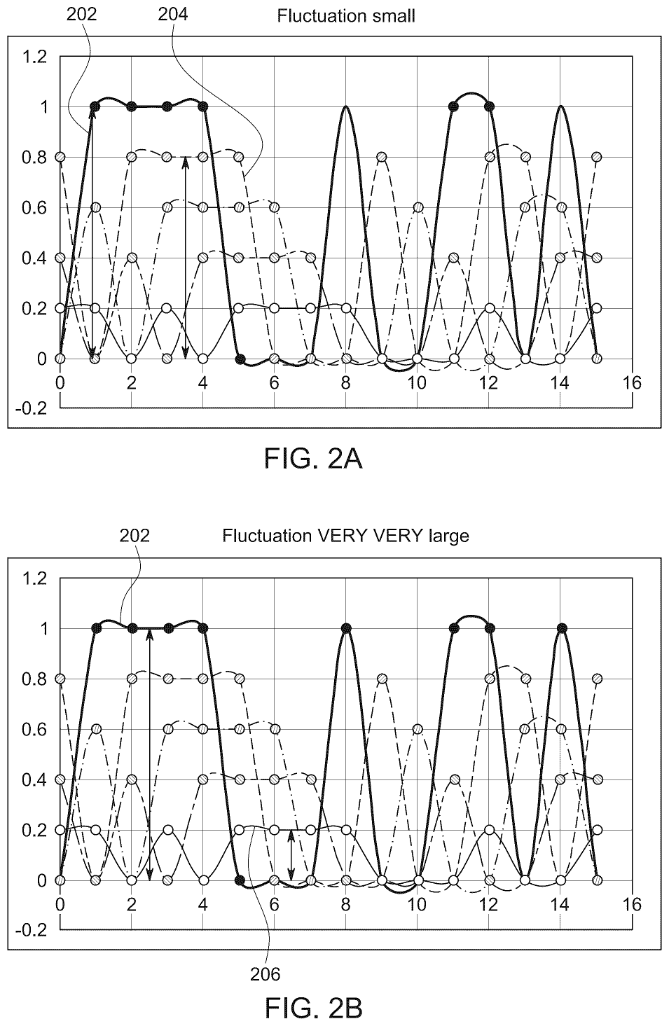

Before turning to the application of an FM-OTDR system to a multi-span, amplified subsea communications system, the basic approach for using FM-OTDR to reduce interference may be considered in the context of a single span. By way of reference, FIG. 2A and FIG. 2B illustrate the optical amplitude vs time from different distances. In FIG. 2A, the scenario is shown for detecting the Rayleigh backscattering from the beginning of a span. Here, the signal [A(t₀)]² (curve 202) is the strongest (Rayleigh reflection from the beginning of a fiber span), and the strongest interference noise is A(t₀) A(t₁) (curve 204). In FIG. 2B, the scenario is shown for detecting the Rayleigh backscattering from the end of the span, where the signal [A(tₙ)]² (curve 206) is the weakest (Rayleigh reflection from the far end of a fiber span), and the strongest interference noise is still A(t₀) A(t₁) (curve 204)—which is much larger than the signal [A(tₙ)]² itself. Please note that [A(tₙ)]² is Golay, while A(tᵢ) A(tᵢ) is not Golay. Hence, these beating terms can't be averaged out with Golay correlation or time average when A(tᵢ) and A(tᵢ) are coherent. It is to be noted that when the signal laser linewidth is larger, just the Rayleigh reflection from adjacent regions is coherent; therefore the coherent beating induced noise can be reduced since more beating terms become incoherent.

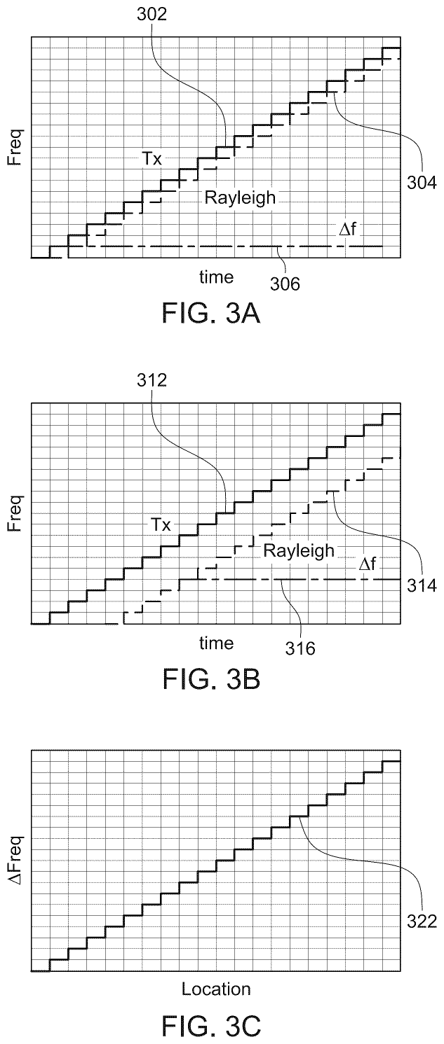

In the present embodiments, a frequency modulated OTDR (FM-OTDR) approach employ modified transmitters that use a frequency modulation system to allow so called beating frequencies of a detected signal to fall out of the signal baseband. To illustrate some principles of operation of the present embodiments, FIG. 3A presents a graph depicting frequency of a given set of signals as a function of time that are generated by an FM-OTDR system consistent with the present embodiments.

The leftward curve, curve 302, illustrates an outbound signal frequency generated by the transmitter as a function of time within one Golay code period. The frequency is incrementally changed in steps, as shown. The rightward curve, curve 304, represents a Rayleigh backscattering signal frequency behavior as a function of time, based upon the outbound signal. The shape of the curve 304 is similar to the shape of curve 302 with a similar frequency/time dependence, where frequency is stepped up vs time. As illustrated, there is a constant time delay or time shift, between the curve 302 and the curve 304, where the magnitude of the delay is determined by the location of the point of origin of the Rayleigh backscattering signal. Therefore, the frequency difference (beating frequency) between any two different Rayleigh backscattering signals will be constant over time, and this constant frequency value is determined by the location difference of the two Rayleigh reflection signals. Said differently, at any given instance in time the frequency difference between the outbound signal and Rayleigh backscatter signal remains constant. For the same reason, the beating frequency between Rayleigh signals generated at two different locations, will be constant with time.

Note that in FIG. 3A, the Rayleigh backscattered signal in question may be assumed to be generated at a location close to the transmitter and receiver of an FM-OTDR system, the beating frequency between a Ray₁ (the Rayleigh backscattered signal from location 1) and a Ray₀ (the Rayleigh backscattered signal from the beginning of the fiber span, or Tx) is constant, but relatively smaller in frequency, as shown in the horizontal curve, curve 306.

Turning to FIG. 3B, there is shown a graph depicting frequency of a given set of signals as a function of time, analogous to FIG. 3A. In the scenario of FIG. 3B, the Rayleigh backscattered signal represents a signal that may be reflected in the middle of a span. In this example, similar to the example of FIG. 3A, the leftward curve, curve 312, illustrates the same outbound signal frequency as curve 302 generated by the transmitter as a function of time within one Golay code period. The rightward curve, curve 314, represents a Rayleigh backscattering signal frequency behavior as a function of time, based upon the outbound signal. Again, the shape of the curve 314 is similar to the shape of curve 312 with a similar frequency/time dependence, where frequency is stepped up vs time. As illustrated, there is a constant time delay or time shift, between the curve 312 and the curve 314, where the magnitude of the delay is determined by the location of the point of origin of the Rayleigh backscattering signal. Thus, in this example, the beating frequency (Δf) between a Rayᵢ and a Ray₀ (or Tx) is constant, as represented by curve 316, but much larger in frequency than curve 306, due to the larger separation in distance between a Rayleigh backscattering signal generated at the very beginning of a span and the Rayleigh backscattering signal generated at a location in the middle of the span.

Turning to FIG. 3C, there is shown a graph depicting the dependence of beating frequency (Δf) as a function of location of origin of a Rayleigh backscattering signal. In particular, the curve 322 depicts the beating frequency between a Rayleigh backscattering signal from a location at a distance z from the beginning of a span, and the Rayleigh backscattering signal generated at the beginning of a span (Tx), as a function of increasing z. As illustrated—the beating frequency is location dependent and increases with increasing distance from the beginning of the span. According to various embodiments of the disclosure, the horizontal units (equivalent to the step length of an individual step) in FIG. 3C are in Golay bit τ_{bit}, or a multiple of a Golay bit.

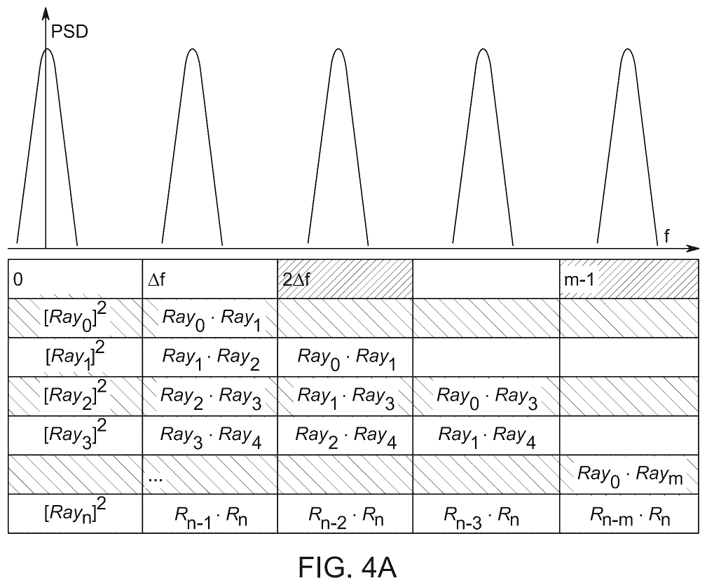

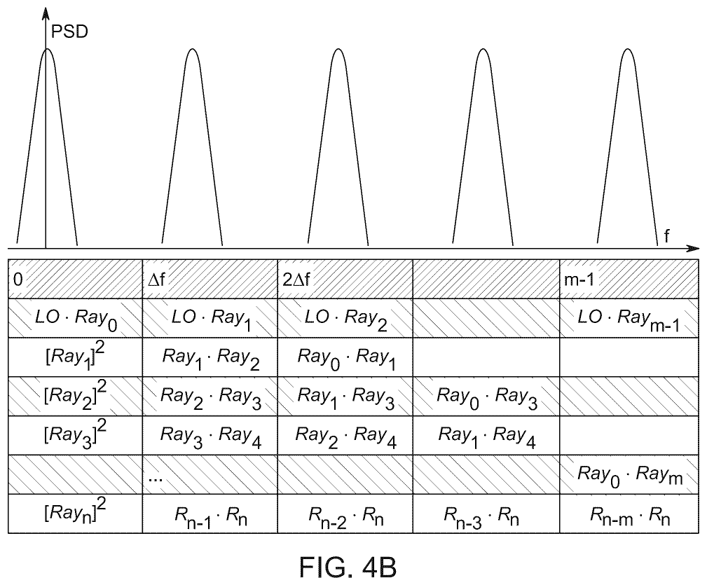

In accordance with various embodiments of the disclosure, the above FM-OTDR approach may be applied in the case of coherent detection as well as non-coherent detection. FIG. 4A is a composite illustration, depicting features of a non-coherent detection scenario. In particular, the graph within FIG. 4A shows the power spectral density (PSD) vs frequency (location) after square law detection. The table in FIG. 4A lists the beating terms that lead to this frequency difference. Only the useful signal-signal beating [A(tₙ)]² falls in the baseband. The beating terms Rayᵢ₋₁Rayᵢ (i=1 to N) falls in the Δf frequency band. These beating signals are coherent and therefore can't be removed by Golay correlation or time averaging. As long as Δf is large enough, in some embodiments of the disclosure, a low pass filter (LPF) having narrow bandwidth may be used to remove all beating frequencies. For example, in one embodiment, a low pass filter (LPF) with 3.5 MHz bandwidth (larger than the baseband Golay signal) may be employed, with the minimum beating frequency Δf arranged to be 10 MHz. In this case, all beating frequencies will be removed by the LPF and won't affect the Golay signal detection.

FIG. 4B is a composite illustration, where the graph depicts the power spectral density (PSD) vs frequency (location) in the case of coherent detection, and the table lists the beating terms that lead to this frequency difference. In this embodiment, a local oscillator (LO) generating an LO signal may be a CW laser without chirp. As illustrated, the LO-Signal beating terms fall in different frequency bands. The beating terms Rayᵢ₋ⱼRayᵢ (i=1 to N) falls in the jΔf frequency band. To recover a signal from location zi, in this embodiment, the approach is to filter out the iΔf band only, down convert the iΔf band to baseband, and then correlate the down-converted baseband signal with the Golay signal. Since the number of interference terms are reduced substantially (especially for a location far away from the transmitter/receiver), the penalty from the harmful signal-signal beating will also be reduced significantly.

While the above examples of FIGS. 2A-4B may be applicable to a scenario for probing a single span of a subsea optical communications system, in other embodiments, a similar approach may be applied in optical communications systems using amplified undersea links including longer trans-oceanic systems. In subsea optical communication systems that employ an amplified link, the signal strength immediately after passing through an amplifier, such as and erbium-doped fiber amplifier (EDFA), is much larger than the signal strength at a location at the end of a preceding span, just before the EDFA. Hence, this fact will have an exceptionally significant impact when measuring a Rayleigh backscattering signal at the end of a given span, for example. Using the FM-OTDR approach of the present embodiments, the beating result caused by strong signals from after an EDFA may be filtered out by use of a LPF in case of incoherent detection or the number of beating terms reduced significantly in case of coherent detection. In various embodiments, a station, such as a terrestrial station, may include a transmitter and a receiver to perform FM-OTDR.

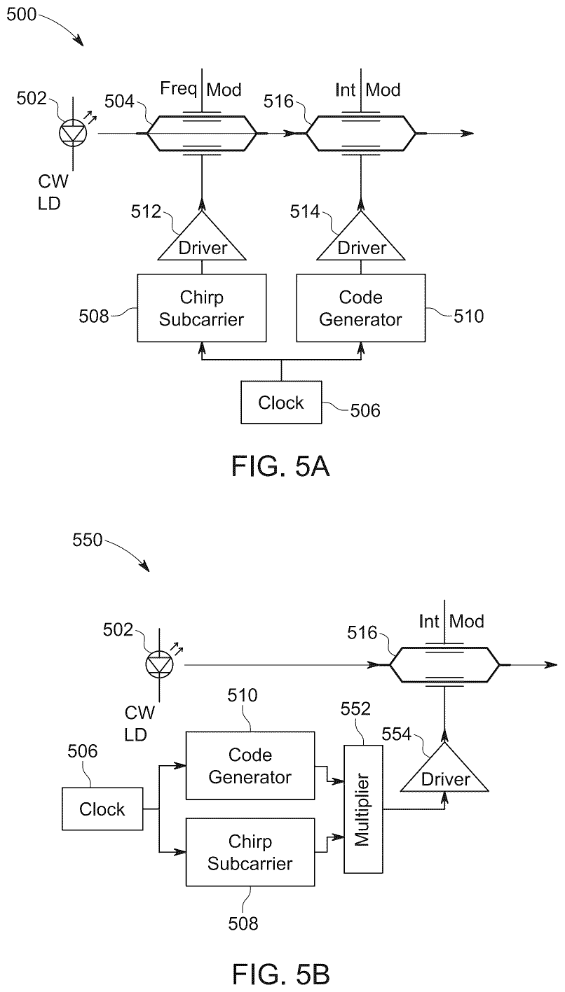

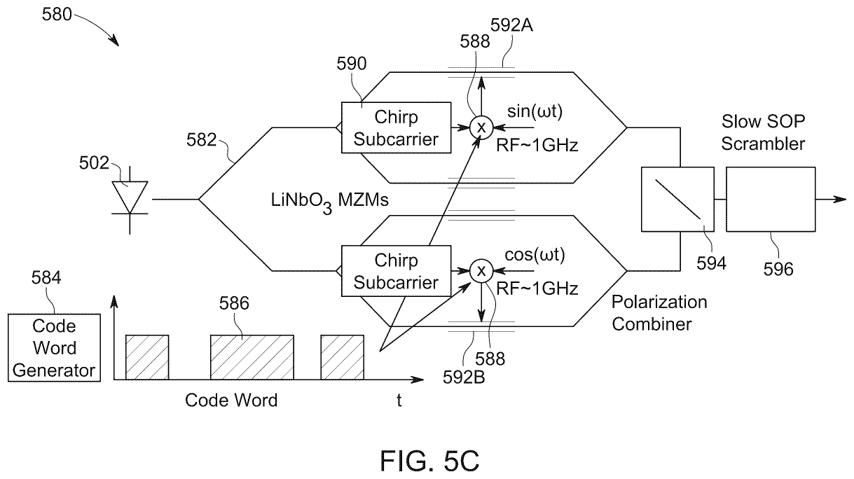

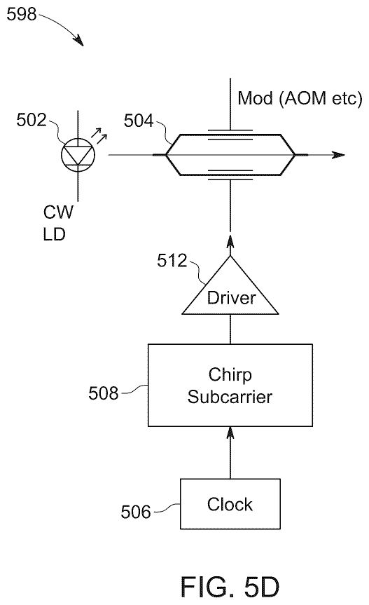

FIG. 5A is a block diagram depicting various components of FM-OTDR system, shown as system 500, according to some embodiments of the disclosure. As illustrated, the system 500 may include a signal source 502, such as a CW laser, which laser may be a laser diode. The output of the signal source 502 is coupled to an optical frequency modulator 504, such as a frequency modulator as known in the art. The system 500 further includes a clock 506 that has and output coupled to chirp subcarrier 508 and also coupled to a code generator 510. The chirp subcarrier 508 may operate in the electrical domain to generate a step chirp, as shown in FIG. 3A and FIG. 3B, or a simple linear chirp as described above. As shown in FIG. 5A, the output of the chirp subcarrier 508 may pass to a driver 512 that has an output coupled to the optical frequency modulator 504. The electrical output of the chirp subcarrier 508 may be modulated into the optical domain by the optical frequency modulator 504.

Similarly, the output of the code generator 510 is transmitted to a driver 514, and thence to an intensity modulator 516, which modulator may be a suitable intensity modulator as known in the art. The code generator 510 may generate Golay code or other simplex code used in correlation to improve sensitivity. In particular, the Golay code or Simplex code that is output by the code generator 510 may be encoded in the intensity modulator 516, which modulator has an input coupled to the modified signal that is output by optical frequency modulator 504.

FIG. 5B is a block diagram depicting various components of FM-OTDR system, shown as system 550, according to other embodiments of the disclosure. Like system 500, the system 550 may include a signal source 502, clock 506, code generator 510, and chirp subcarrier 508. In this case, the signal source 502 is directly coupled to intensity modulator 516. In this embodiment, the output of the chirp subcarrier 508 and output of the code generator 510, such as Golay/simplex code are multiplexed together in a multiplexer 552, and then the multiplexed output is sent through driver 554 to be modulated by a single intensity modulator, meaning the intensity modulator 516. This arrangement may be less costly than the arrangement of FIG. 5A.

Referring again to the FIG. 3A and FIG. 3B, it may be assumed that the outbound signal from the transmitter, as represented by curve 302 and curve 312, respectively, is generated having a chirp period that is the same as the Golay word period τ_{word}. This requirement can be relaxed in the cases where laser linewidth is wider. The transmitter chirp period depends on the laser coherent length L_{coh} or coherence time τ_{coh}, which entity is determined by laser linewidth

$$Δ v . {L}_{coh} = c \cdot {τ}_{coh} = \frac{c}{π \cdot Δ v} .$$

As long as the chirp period is >3τ_{coh}, the optical pulse is not coherent anymore. In such case, the use of Golay correlation or time averaging will be able to reduce the fluctuation from signal-signal beating. Therefore, the curve 302 and/or curve 304 of FIG. 3A and FIG. 3B, respectively, can have chirp multiple cycles with reduced frequency chirp range within one Golay word period, as long as a single chirp period is longer than three times the laser coherent time. Reducing the chirp period from τ_{word} to 3τ_{coh}, the maximum frequency range of the transmitter is also reduced accordingly. Hence, in these embodiments, the transmitter may employ lower speed modulators and drivers.

Note that in optical transmission systems using coherent technology, the LME probe (low-speed high power pulses) can degrade performance of neighboring data channels, even causing uncorrected word blocks in some cases. This degradation originates from fast SOP (State of Polarization) changes that are induced in the data channel by a polarized LME tone. In prior approaches, a fast polarization spinning technique has been suggested to mitigate the aforementioned penalty to data carrying channels.

In further embodiments of the disclosure, the FM-OTDR scheme disclosed herein may be combined a modified fast polarization spinning technique to reduce both polarized LME-induced penalty and signal-signal beating induced interference noise penalty. FIG. 5C depicts a modified FM-OTDR system, shown as system 580, according to other embodiments of the disclosure. In the approach shown in FIG. 5C. The chirped subcarrier is multiplexed in the electrical domain with the code word and a high frequency (e.g., 1 GHZ) signal (from a signal generator, not separately shown) to generate polarization spinning. In this case, a dual polarization IQ (In-phase and Quadrature) modulator may be required. An electrical driver may be used (not shown) to boost the electrical power to the IQ modulator. In the system 580, a signal source 502, such as a CW laser diode, is coupled to an electrooptic modulator 582 a code word generator 584 outputs a code word 586 that is transmitted to a pair of multiplexers 588, and combined with a chirp signal generated by chirp subcarriers 590. The output from the chirp subcarriers 590 and code word generators 584 is sent to the multiplexers 588 and combined with a polarized signal for each of the two polarization branches, generating a modified signal that is output to a respective one of the intensity modulators 592A and 592B for each of polarized signals. The polarized output from the intensity modulators 592A and 592B is sent to a polarization combiner 594, and then transmitted to slow SOP scrambler 596. Note that the output from intensity modulator 592A is proportional to sin(ωt), while the optical amplitude from the intensity modulator 592B is cos(ωt). After the polarization combiner 594, just the frequency shift relative to the input optical signal will be seen. If the driving voltage has linear frequency change “ω” (linear chirp), a linear optical frequency chirp will be observed. This frequency chirp is generated with 2 optical intensity modulators with complementary power, so just frequency change is observed, but not power change.

In various embodiments the electrooptic (EO) modulator may be a lithium niobate based Mach-Zender modulator (MZM), though other EO modulators are also suitable for the system 580.

FIG. 5D depicts another FM-OTDR system according to further embodiments of the disclosure, shown as system 598. The system 598 may be arranged similarly to system 500, with like components labeled the same. A difference is that the system 598 omits the code generator 510 and intensity modulator 516, providing a less complex design, albeit without the enhancement of weak signals that are provided by the codes.

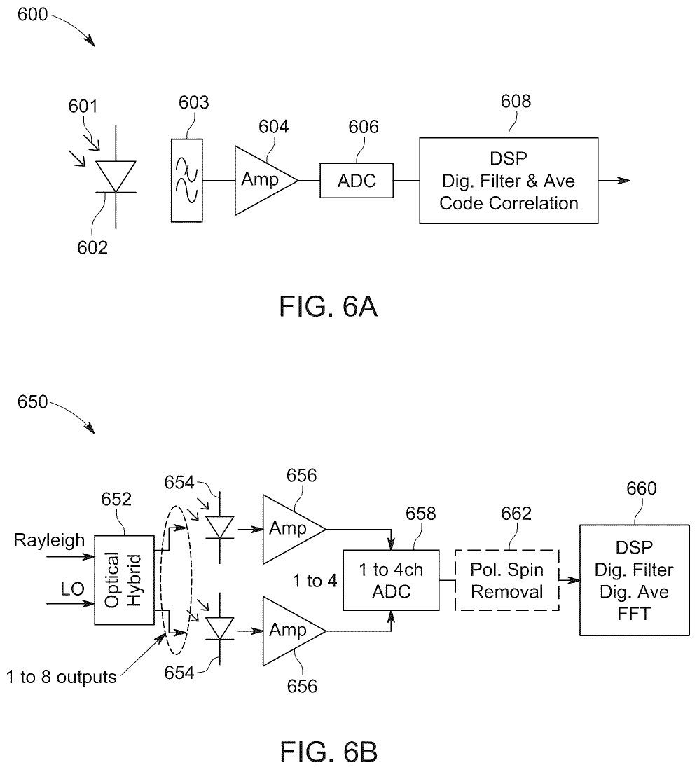

FIG. 6A depicts a block diagram of a receiver 600 for an FM-OTDR system, according to some embodiments of the disclosure. In this example, the receiver 600 is arranged for incoherent detection (square law detection). In incoherent detection the optical Rayleigh backscattering signal 601 is converted to electrical signal by a photodetector 602, such as a photodiode. The electrical signal is filtered by a low-pass filter 603 to remove all signal-signal beating noise from various locations and then amplified by an amplifier 604. Afterwards, the filtered electrical signal is treated by a regular OTDR digital signal processing (DSP) procedure, shown as digital signal processor (DSP) block 608: the filtered analog electrical signal is converted to a digital signal using an analog-to-digital converter (ADC 606), the subjected to digital filtering and averaging the signal (using moving average or periodically time averaging), code correlation and other techniques to enhance SNR. While the receiver 600 may be used in conjunction with transmitters shown in FIG. 6A or FIG. 6B, in variants where the transmitter employs fast polarization spinning (see FIG. 5C), the receiver block diagram of FIG. 6A will remain the same as shown, since the 1 GHz polarization modulation is removed automatically after the square law detection.

FIG. 6B depicts a block diagram of a receiver 650 for an FM-OTDR system, according to additional embodiments of the disclosure. In this example, the receiver 650 is arranged for coherent detection. The receiver 650 includes an optical hybrid 652. In the case of coherent detection, an optical Rayleigh backscattering signal is first beat with a local oscillator (LO) (split from a CW laser diode from the transmitter). In different embodiments, the output from the optical hybrid 652 may range from 1 output to 8 outputs—e.g., 1 output for the case of single polarization, single quadrature, and single ended detection; and a maximum of 8 outputs for the case of 2 polarizations, quadrature, and all balanced detections. While FIG. 6B depicts an arrangement of two photodetectors (PD) (see photodetectors 654), according to various embodiments of the disclosure, the outputs from the optical hybrid 652 may be converted to electrical signals by a single PD or up to 4 balanced PDs. Then the electrical signals are amplified using an assembly of amplifiers 656, and converted to digital signals using 1 to 4 channel ADCs 658. Afterwards, at DSP block 660, the signals are digitally filtered and digitally averaged, converted to frequency domain using a fast Fourier transform (FFT). In some embodiments, code correlation and other techniques may also be applied to enhance SNR. At the end, the frequency signals are converted to physical locations to get the response from distinct locations along the optical link, according to the principles disclosed above.

In embodiments that employ fast polarization spinning from the transmitter, the high frequency (˜1G) polarization modulation may be removed with a polarization removal component, shown as polarization spin removal block 662, such as a homodyne detector/heterodyne detector or a square law detector in the electrical domain (see the dashed optional box). Thus the Rayleigh backscattering signal may be a polarization-spin-modified optical signal. After the polarization modulation removal, the regular DSP including digital filtering, digital averaging, FFT etc. maybe performed.

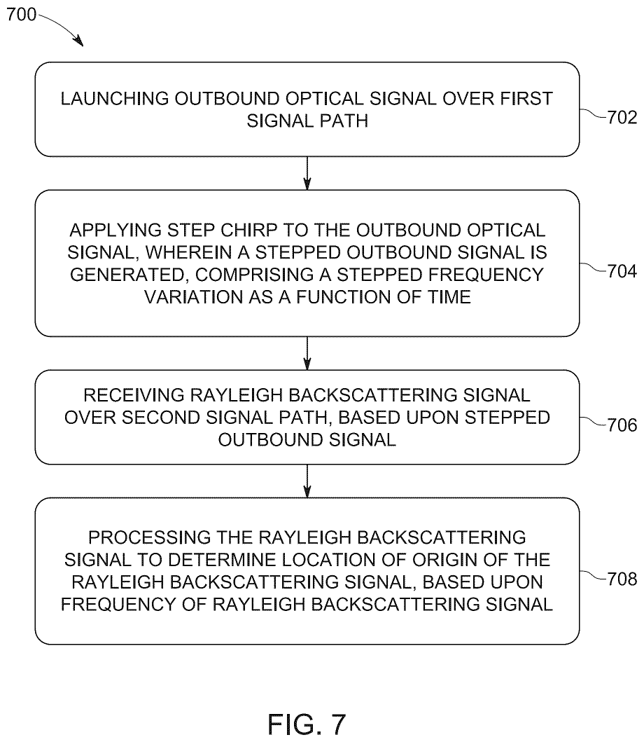

FIG. 7 presents an exemplary process flow 700. At block 702 an outbound optical signal is launched over a first signal path. At block 704, a step chirp is applied to the outbound optical signal, which that a stepped outbound optical signal is generated, characterized by a stepped frequency variation as a function of time. At block 706, a Rayleigh backscattering signal is received over a second signal path, based upon the stepped outbound optical signal. At block 708, the Rayleigh backscattering signal is processed to determine the location of the origin of the Rayleigh backscattering signal, based upon the frequency of the Rayleigh backscattering signal.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation, in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A sensing system comprising:
a transmitter to launch an outbound optical signal;
a clock to generate a clock signal;
a chirp subcarrier coupled to the clock and configured to generate a chirp;
a code generator coupled to the clock and configured to generate a code; and
an intensity modulator, arranged to modulate the outbound optical signal and coupled to receive an intensity modulator signal wherein the intensity modulator signal is derived at least in part from the code generator.

2. The sensing system of claim 1, further comprising a frequency modulator, arranged to modulate the outbound optical signal, and output a result to the intensity modulator, wherein the chirp subcarrier is coupled to the frequency modulator.

3. The sensing system of claim 2, the transmitter further comprising an electrooptic modulator arranged as a dual polarization IQ modulator.

4. The sensing system of claim 3, wherein the electrooptic modulator is arranged to split the outbound optical signal into a pair of outbound optical signals, wherein the transmitter further comprising:
a signal generator to generate a high frequency signal;
a multiplexer to mix the high frequency signal with a chirp signal from the chirp subcarrier and output a polarization spin signal to each of the pair of outbound optical signals; and
a polarization combiner to combine the pair of outbound optical signals.

5. The sensing system of claim 1, further comprising a receiver to receive a Rayleigh reflection signal based upon the outbound optical signal, the receiver comprising:
a photodetector to convert the Rayleigh reflection signal into an analog electrical signal; and
an analog to digital converter to convert the analog electrical signal into a digital electrical signal; and
a digital signal processor, to perform a filtering and average code correction on the digital electrical signal.

6. The sensing system of claim 5, the receiver further comprising:
a local oscillator, to generate an LO signal;
an optical hybrid to receive the Rayleigh reflection signal and the LO signal, and to generate a plurality of optical output signals; and
a plurality of photodetectors to convert the plurality of optical output signals into a respective plurality of electrical signals.

7. The sensing system of claim 6, wherein the Rayleigh reflection signal comprises a polarization-spin-modified optical signal, the receive further comprising:
a polarization removal component to remove a high frequency polarization modulation from the Rayleigh reflection signal.

8. The sensing system of claim 7, the polarization removal component comprising a heterodyne detector, a homodyne detector, or a square law detector.

9. An optical communication system, comprising:
a transmitter to launch a line monitoring signal (LMS) as an outbound optical signal along an outbound path; a loopback to route a Rayleigh reflection signal based upon the LMS to a return path; and
a receiver to receive the Rayleigh reflection signal from the return path, wherein the transmitter comprises:
a clock to generate a clock signal;
a chirp subcarrier coupled to the clock and configured to generate a chirp;
a code generator coupled to the clock and configured to generate a code; and
an intensity modulator, arranged to modulate the outbound optical signal and coupled to receive an intensity modulator signal that is derived at least in part from the code generator.

10. The optical communication system of claim 9, the transmitter further comprising a frequency modulator, arranged to modulate the outbound optical signal, and output a result to the intensity modulator, wherein the chirp subcarrier is coupled to the frequency modulator.

11. The optical communication system of claim 10, the transmitter further comprising an electrooptic modulator arranged as a dual polarization in phase quadrature modulator.

12. The optical communication system of claim 11, wherein the electrooptic modulator is arranged to split the outbound optical signal into a pair of outbound optical signals, wherein the transmitter further comprising
a signal generator to generate a high frequency signal;
a multiplexer to mix the high frequency signal with a chirp signal from the chirp subcarrier and output a polarization spin signal to each of the pair of outbound optical signals; and
a polarization combiner to combine the pair of outbound optical signals.

13. The optical communication system of claim 9, further comprising a receiver to receive a Rayleigh reflection signal based upon the outbound optical signal, the receiver comprising:
a photodetector to convert the Rayleigh reflection signal into an analog electrical signal; and
an analog to digital converter to convert the analog electric signal into a digital electrical signal; and
a digital signal processor, to perform a filtering and average code correction on the digital electrical signal.

14. The optical communication system of claim 13, the receiver further comprising:
a local oscillator, to generate an LO signal;
an optical hybrid to receive the Rayleigh reflection signal and the LO signal, and to generate a first and a second optical output signal;
an optical hybrid to receive the Rayleigh reflection signal and the LO signal, and to generate a plurality of optical output signals; and
a plurality of photodetectors to convert the plurality of optical output signals into a respective plurality of electrical signals.

15. The optical communication system of claim 14, wherein the Rayleigh reflection signal comprises a polarization-spin-modified optical signal, the receive further comprising:
a polarization removal component to remove a high frequency polarization modulation from the Rayleigh reflection signal.

16. The optical communication system of claim 15, the polarization removal component comprising a heterodyne detector, a homodyne detector, or a square law detector.

17. A method, comprising:
launching an outbound optical signal over a first signal path;
applying a step chirp to the outbound optical signal, wherein a stepped outbound signal is generated, comprising a stepped frequency variation as a function of time;
receiving a Rayleigh backscattering signal over a second signal path, the Rayleigh backscattering signal being based upon the stepped outbound signal; and
processing the Rayleigh backscattering signal to determine a location of an origin of the Rayleigh backscattering signal, based upon a frequency of the Rayleigh backscattering signal.

18. The method of claim 17, further comprising applying a code word to the outbound optical signal.

19. The method of claim 18, further comprising applying polarizing spinning to the outbound optical signal.

20. The method of claim 17, the processing the Rayleigh backscattering signal comprising:
generating an analog electrical signal from the Rayleigh backscattering signal;
converting the analog electrical signal into a digital electrical signal; and
performing a code correction on the digital electrical signal.
